(19) United States
(12) Patent Application Publication
(10) Pub. No.: US 2003/0117794 A1
(43) Pub. Date: Jun. 26, 2003

(54) Flat color-shift medium

(76) Inventors: Tien-Rong Lu, Tainan (TW); Mao-Kuo Wei, Hsin Chu (TW); Shea-Jue Wang, Hsin Chu (TW)

Correspondence Address: BIRCH STEWART KOLASCH & BIRCH, PO BOX 747, FALLS CHURCH, VA, 22040-0747, US

(21) Appl. No.: 10/322,508

(22) Filed: Dec. 19, 2002

(30) Foreign Application Priority Data
Dec. 20, 2001 (TW) 090131761

(51) Int. Cl. F21V 9/16

(52) U.S. Cl. 362/84

(57) ABSTRACT

A flat color-shift medium which is positioned on a backlight of an organic light-emitting source. The flat color-shift medium is made of uniformly mixed fluorescent materials, each of which has a specific dose ratio. Due to the microcosmic light-color mixing effect of the fluorescent materials, the flat color-shift medium could shift an original spectrum of shorter wavelength into a desired spectrum of longer wavelength.

### BACKGROUND OF THE INVENTION

1. Field of Invention

The invention relates to a flat color-shift medium and, in particular, to a flat color-shift medium structure that can shift an original spectrum of shorter wavelength of a backlight of organic light-emitting devices into the desired spectrum of longer wavelength.

2. Related Art

In the trend towards lighter, thinner, smaller and compact of optoelectronical devices, a light source, in particular a flat light source, plays an important role in the entire display or measurement industries. In LCD (liquid-crystal display), for example, if the development of light source cannot match the flat elements such as a thin-film transistor, a polarized light panel, and a color filter, the thickness of the whole LCD cannot become thinner. Therefore, LCD may fail to fit the current trend of lighter, thinner, smaller and compact. Consequently, the development of a flat light source, especially a white light source, is in very urgently for the entire display and illumination technologies.

Although the conventional incandescent lights, halogen light and fluorescent light have advantages in high brightness and low cost, they are based on blackbody emission induced by high temperatures, which is generated from the high resistance, or fluorescent materials hit by the dissociated gas. However, the mentioned high temperature may increase the loading of heat dissipation to the devices. Moreover, the high temperature may induce the degradation of organic materials used in the devices and damage the devices. In addition, the conventional incandescent lights are cylinder structures, so that they cannot be reshaped into planar to be applied in the current optoelectrical devices.

Incandescent light, halogen light and fluorescent light may be utilized as backlights in conventional LCD industries, but these backlights, which are cylinder structures, cannot illuminate uniformly. Therefore, additional light guide, reflecting plate, diffusion plate, and prism are required to increase the uniformity of light. However, the stacking of additional elements in LCD increased the thickness, decreased the emitting efficiency, and inflated the cost.

Recently, the blue and white LED, light emitting diode is utilized as flat light source. However, there are some problems in the white LED such as high cost of epitaxial materials and expansive sapphire substrates, difficulties of manufacturing process, and low emitting efficiencies. Above all, it is a big issue to grow wide substrates and thin films of Gallium Arsenide or Gallium Nitride epitaxial for utilizing the LED in the illumination industry. Furthermore, the non-planar cap feature of LED breaks the planar feature of epitaxial substrates and thin films of Gallium Arsenide or Gallium Nitride, so that LED is no longer planar. Moreover, a white LED is composed of a red, blue, and green diode emitting devices, which have different lifetimes and stabilities leading to the drawbacks of complex circuit design.

Hence, new organic light-emitting devices, OLED, are required to successively overcome the problems of lamp light and LED. In conventional OLED, a red emitting material, a blue emitting material and a green emitting material are utilized to luminesce a white light. The emitting materials of three primary colors are evaporated on the pixels of substrates by the order of lateral side-by-side (S×S). In macroscopic view, the red, blue and green pixels could be mixed into a white light emission. However, as referring to FIG. 1, when the mentioned lateral side-by-side is used to generate a white light, it is necessary to arrange red emitting pixels 111, green emitting pixels 112, and blue emitting pixels 113 as the structure shown in FIG. 1. When a light source 100 pass through the structure, a white light 11 can be generated. In this case, lateral side-by-side arrangement is used, so the light mixing effect occurs only after the light diffuses in lateral direction. The white light may disperse color tones and luminance of the emitting devices. In addition, it is difficult to selectively evaporate and located the color emitting materials on the pixels of the panel by using related planar white light mixing technology, so that the manufacturing of these products is typically costly, low yield, laborious to fabricate and lack the properties required for wide use and distribution. In addition, another stacking structure of red, blue and green emitting layers are applied in a fully transparent stacked OLED. In macroscopic view, the vertical stacked red, blue and green organic emitting materials can respectively emit a red, blue and green light. With reference to FIGS. 2A and 2B, for example, if this structure is used to generate a white light, the color-shift medium 211 is a stacked structure as shown in FIG. 2A. In other words, the green emitting layer 2111, red emitting layer 2112, and blue emitting layer 2113 are stacked on the substrate 210 in vertical sequence. When the light source 200 passes through the color-shift medium 211, a white light 21 as shown in FIG. 2B is generated. However, the manufacturing process of this stacked structure is too complex to apply in mass production leading to a low yield. Further, each emitting layer may absorb the light so as to reduce the light-emitting efficiency of each color. Thus, the stacked emitting structures may increase the thickness, reduce luminescent efficiency, and raise cost of the stacked OLED.

In the above-mentioned structures, a poor color and light uniformity may occur if lateral or vertical color mixing is utilized. In the related planar white light mixing technology, it is difficult to evaporate and located the color emitting materials on a specific pixel, so the yield of manufacturing process is decreased. The vertical stacked structure may generate the difference of light absorption between the emitting layers, so the white light is poor luminescent efficiency.

Referring to U.S. Pat. No. 6,252,254 (light emitting device with phosphor composition), a red, blue and green LED is arranged in adjacent locations so as to generate light mixing effect by light diffusion. However, the generated white light may disperse color tones and luminance of the emitting devices, so that the white light spectrum may be unsatisfied. Each LED has a specific emitting function and driving model, so the light may be emitted toward different directions. Thus, the generated light may not be uniformly mixed. In addition, these LED are made of different materials, respectively, and they have different driving voltages. Therefore, a predicted voltage is required in this case, so that the design of the driving circuit is very difficult. Moreover, each LED has specific reliability, stability, and lifetime. Therefore, the color of emitting light may shift as time goes by and environment temperature changes, so that the products may fail in stability and reliability tests and lack the properties required for extensive use and distribution.

### SUMMARY OF THE INVENTION

The present inventors have eagerly investigated for solving the above problems. In this invention, a flat color-shift medium is disclosed to solve the above-mentioned problems.

It is an objective of the invention to provide a simple, manufacturing suitable, high brightness, and uniform flat color-shift medium to shift a backlight into the desired spectrum of light.

It is another objective of the invention to provide a flat color-shift medium to improve the viewing angle of optoelectronical devices.

It is yet another objective of the invention to provide a flat color-shift medium to simplify structures so as to reduce manufacturing cost, to be readily applied on the current backlight directly to generate the desired color, to avoid risks and costs for developing new color emitting materials and devices, to speed up the image response time, and to produce lighter and thinner products.

To achieve the above objective, a flat color-shift medium, according to an exemplary embodiment of the invention, is made of a uniformly mixed fluorescent materials, each of the fluorescent materials having a specific dose ratio, wherein the fluorescent materials have color mixing effect and is utilized to shift an original spectrum of shorter wavelength into the desired spectrum of longer wavelength, rather than the conventional lateral or vertical color mixing.

### BRIEF DESCRIPTION OF THE DRAWINGS

The invention will become more fully understood from the detailed description given in the herein below illustration, and thus are not confined of the present invention, and wherein:

FIG. 1 is a schematic view of the structure of a prior white light device;

FIGS. 2A and 2B are schematic views of the structure of another prior white light device; and

FIGS. 3A and 3B are schematic views of an embodiment of the disclosed flat color-shift medium.

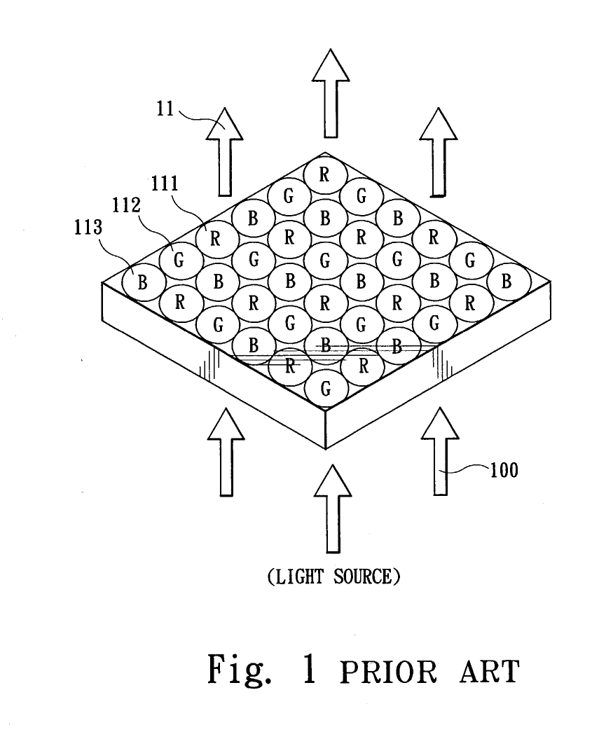

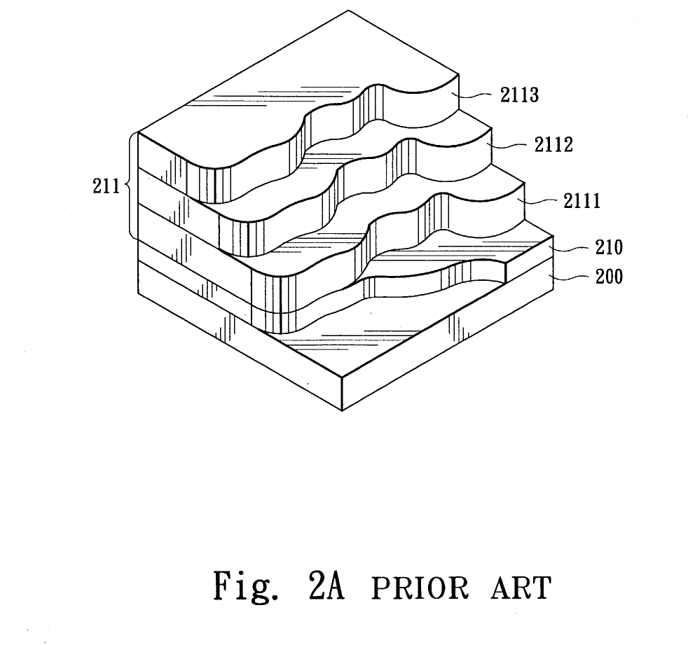

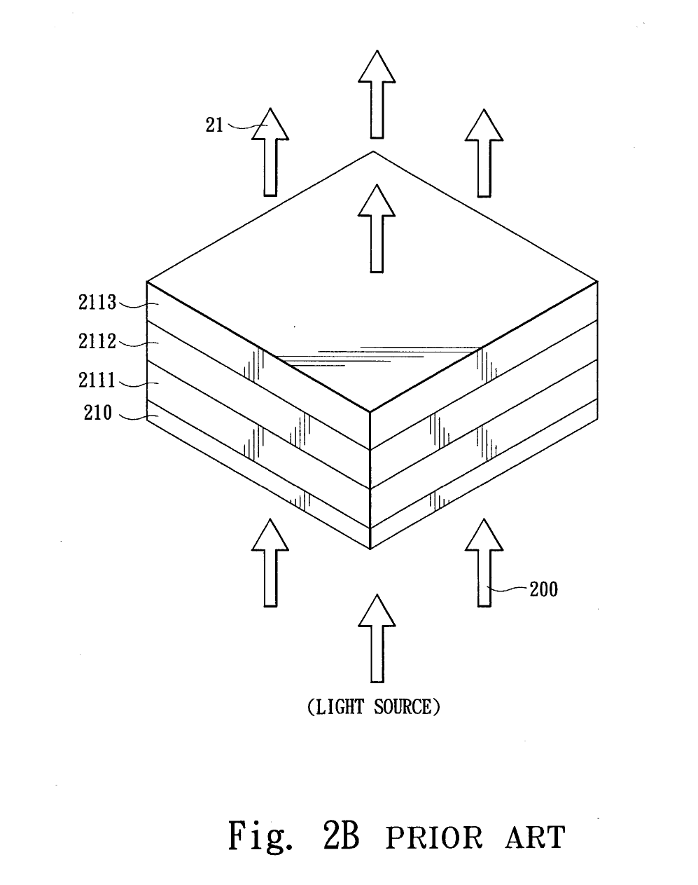

### DETAILED DESCRIPTION OF THE INVENTION

In this invention, a flat color-shift medium is positioned on a backlight of an organic light-emitting panel, and is made of uniformly mixed fluorescent materials. According to the microcosmic color mixing effect of the fluorescent materials, an original spectrum of shorter wavelength emitted from the backlight is shifted into the desired spectrum of longer wavelength.

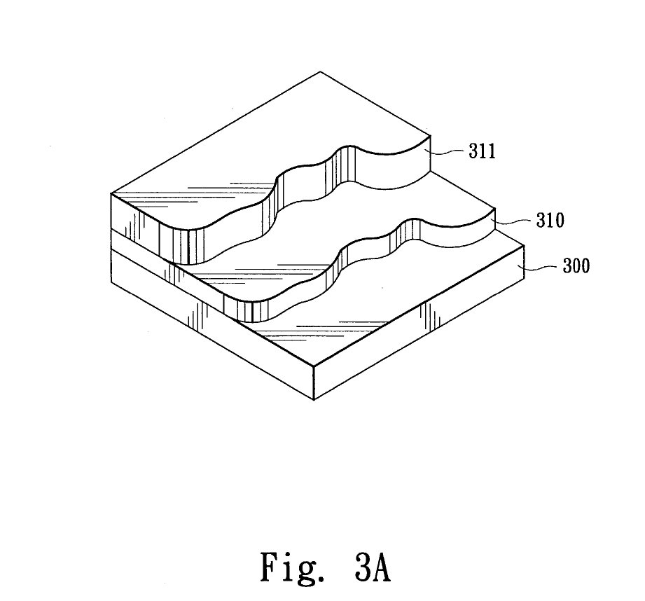

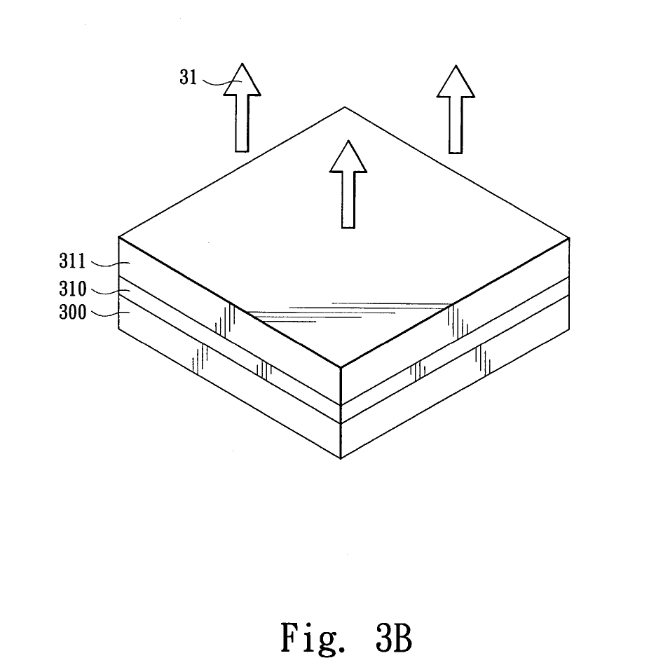

As shown in FIGS. 3A and 3B, a flat color-shift medium 311 of this invention is consisted of a transparent medium and at least one inorganic fluorescent material, such as YBO₃:Ce³⁺,Tb³⁺; SrGa₂S₄:Eu²⁺; Y₂O₂S:Eu³⁺,Bi³⁺; YAG:Ce³⁺; SrGa₂O₄:Eu²⁺; and CaS:Eu.

The transparent medium and inorganic fluorescent materials are uniformly mixed, wherein each of the inorganic fluorescent materials has a specific dose ratio. The flat color-shift medium 311 having microscopic color mixing effect of fluorescent materials is provided on a backlight 310. When the backlight 310, such as an organic light-emitting device, emits a shorter wavelength spectrum such as an UV light or a blue light, the color-shift medium 311 can absorb the shorter wavelength spectrum and shift it into the desired wavelength spectrum. Therefore, the desired spectrum is obtained. In addition, the fluorescent materials of this invention are inorganic fluorescent materials, which have better stability, quality and lifetime than organic fluorescent materials. In this case of white light, when the fluorescent materials are provided according to a principle for balancing the luminous efficiency of three primary colors of different fluorescent materials, a white light spectrum can be radiated. For example, as shown in FIG. 3B, to adjust the ratio of fluorescent materials can achieve the objective of shifting the shorter wavelength spectrum of backlight 310 into a longer wavelength spectrum, such as the white light 31.

The structure of color-shift medium can be formed on the backlight by a wet coating process. In the wet coating process, different fluorescent materials, such as YBO₃:Ce³⁺,Tb³⁺; SrGa₂S₄:Eu²⁺; Y₂O₂S:Eu³⁺,Bi³⁺; YAG:Ce³⁺; SrGa₂O₄:Eu²⁺; and CaS:Eu, can be mixed with a transparent medium according to the principle for balancing the luminous efficiency. The transparent medium, for example, is transparent Silicon Oxide, Titanium Oxide, or Epoxy. In this case, the fluorescent materials and transparent medium are weighted directly and uniformly mixed. In addition, they can be mixed by sol-gel method or by co-precipitation method. In co-precipitation method, the fluorescent materials and transparent medium are mixed under atomic level, and are added into an appropriate solvent or a sol for gelling. On the other hand, the solution prepared by co-precipitation method can be flatly and uniformly formed on a substrate by spin coating method or printing method. Next, the solution is dried to move water and solvent away. After that, a passivation layer, which is made of an acrylic resin, a fluorinated resin, a silicon nitride thin film, or an epoxy resin, is coated or deposited on the color-shift medium to protect the structure of flat color-shift medium. Furthermore, the flat color-shift medium of the present invention further includes a substrate 300, which is selected from a plastic, a glass, or a silicon wafer. The substrate 300 may further include an electrical conductive material, which is selected from ITO, IZO, metal, or alloy. The electrical conductive material is formed between the substrate 300 and backlight 310.

Alternatively, the structure of color-shift material can be formed on the backlight by a dry deposition process. In the dry deposition process, fluorescent materials, such as YBO₃:Ce³⁺, Tb³⁺; SrGa₂S₄:Eu²⁺; Y₂O₂S:Eu³⁺,Bi³⁺; YAG:Ce³⁺; SrGa₂O₄:Eu²⁺; and CaS:Eu, and a transparent medium, such as transparent Silicon Oxide, Titanium Oxide, or Epoxy, are weighted, mixed and pressed to be a target. The target can also be prepared by sol-gel method or co-precipitation method. Next, the target is deposited on the substrate by evaporation, sputtering, or ion-beam method so as to form a flat color-shift medium. In the dry deposition process, the flat color-shift medium is formed according to a principle for balancing the deposition rate differences among different fluorescent materials, so as to generate the desired spectrum. In the same deposition process, another silicon nitride or diamond like thin film is deposited as a passivation layer. In addition, a passivation layer, which is made of an acrylic resin, a fluorinated resin, a silicon nitride thin film, or an epoxy resin, is coated or deposited to form a flat color-shift medium with a passivation layer. Furthermore, the flat color-shift medium of the present invention further includes a substrate 300, which is selected from a plastic, a glass, or a silicon wafer. The substrate 300 may further include an electrical conductive material formed between the substrate 300 and backlight, which is selected from ITO, IZO, metal, or alloy.

The invention discloses a color-shift medium of single layer structure, which is microscopically doped with particle scale fluorescent materials. Therefore, the invention could provide a simple, manufacturing suitable, high luminance, and uniform flat color-shift medium to cooperate with a backlight. In this case, the thickness of the flat color-shift medium of the invention is substantially smaller than 1.4 mm. The flat color-shift medium not only can radiate uniform and bright light, but also can be simply manufactured. Further, the driving voltage of the emitting device with the color-shift medium is low, so that the opotoelectronical device has environmental safety without the Mercury pollution.

Although the conventional incandescent light, halogen light and fluorescent light have advantages in luminance and low cost, they luminesce according to blackbody emissive induced by high temperature, which is generated from the high resistance, or fluorescent materials hit by the low-pressure dissociated gas. However, the mentioned high temperature may increase the loading of heat dissipation of the devices. Moreover, the high temperature may induce the degradation of organic materials in the devices and damage the devices. In addition, the conventional lights are cylinder structures, so that they cannot be reshape to planar while being applied in the current opotoelectronical devices. Besides, the fluorescent material used in conventional light is Mercury, which is harmful to our environment.

In brief, the flat color-shift medium of the invention has the following advantages of wide viewing angle, low cost, fast response time, wide available temperature range, lightening and thinning suitable, and matching up the requirement of multimedia technologies.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A flat color-shift medium which is positioned on a backlight of an organic light-emitting device, characterized in that the flat color-shift medium is made of at least one uniformly mixed fluorescent material, each of the fluorescent material having a specific dose ratio, wherein the fluorescent material has color mixing effect and are utilized to shift an original spectrum of shorter wavelength into a desired spectrum of longer wavelength.

2. The flat color-shift medium of claim 1, wherein the fluorescent materials are consisted of at least one red inorganic fluorescent material, blue inorganic fluorescent material, and green inorganic fluorescent material.

3. The flat color-shift medium of claim 1, further comprising a transparent medium, wherein the fluorescent materials are doped in the transparent medium.

4. The flat color-shift medium of claim 3, wherein the transparent medium is selected from Silicon Oxide, Titanium Oxide, or Epoxy.

5. The flat color-shift medium of claim 1, wherein the specific dose ratio of each of the fluorescent materials is determined by the desired spectrum according to a principle for balancing the luminous efficiency of three different color fluorescent materials.

6. The flat color-shift medium of claim 1, wherein the flat color-shift medium is formed on the backlight of organic light-emitting device by a wet coating process.

7. The flat color-shift medium of claim 1, wherein the flat color-shift medium is formed on the backlight of organic light-emitting device by a dry deposition process.

8. The flat color-shift medium of claim 7, which is formed by the dry deposition process according to a principle for balancing the deposition rate differences among different fluorescent materials, so as to generate the desired spectrum.

9. The flat color-shift medium of claim 1, wherein the original spectrum is selected from an UV light or a blue light.

10. The flat color-shift medium of claim 1, further comprising a substrate, wherein the substrate is selected from a plastic, a glass, or a silicon wafer.

11. The flat color-shift medium of claim 10, wherein the substrate further comprises an electrical conductive material formed between the substrate and backlight of organic light-emitting device, wherein the electrical conductive material is selected from ITO, IZO, metal, or alloy.

12. The flat color-shift medium of claim 1, the thickness of the flat color-shift medium is substantially smaller than 1.4 mm.

13. The flat color-shift medium of claim 1, wherein the fluorescent material is selected from the group consisting of YBO₃:Ce³⁺,Tb³⁺; SrGa₂S₄:Eu²⁺; Y₂O₂S:Eu³⁺,Bi³⁺; YAG:Ce³⁺; SrGa₂O₄:Eu²⁺; and CaS:Eu.

14. The flat color-shift medium of claim 1, wherein the desired spectrum is a white light.

15. The flat color-shift medium of claim 1, wherein a transparent encapsulation material is covered the flat color-shift medium.

16. The flat color-shift medium of claim 15, wherein the transparent encapsulation material is selected from an acrylic resin, a fluorinated resin, a silicon nitride thin film, or an epoxy resin.
